(19) United States
(12) Patent Application Publication
(10) Pub. No.: US 2012/0230023 A1
(43) Pub. Date: Sep. 13, 2012

(54) LINEAR LIGHT SOURCE, LIGHT GUIDE, AND OPTICAL SCANNING MODULE

(75) Inventor: JUN-FENG LIN, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/240,243

(22) Filed: Sep. 22, 2011

(30) Foreign Application Priority Data
Mar. 10, 2011 (CN) 201110062024.6

(51) Int. Cl. F21V 7/06

(52) U.S. Cl. 362/217.06

(57) ABSTRACT

A linear light source emits light beams for illuminating a target. The linear light source includes a light guide, a light-emitting unit, and a reflecting layer. The light guide has a bottom surface, first and second reflecting surfaces extending from opposite side edges of the bottom surface, respectively, and a light converging convex surface connected to the first and second reflecting surfaces and curved outward with respect to the bottom surface. The first and second reflecting surfaces are symmetrical segments of an imaginary parabolic curved surface having a parabolic transverse section opening toward the light converging convex surface. The light-emitting unit is for emitting light beams that propagate along the light guide and that exit via the light converging convex surface. The reflecting layer is disposed on the first and second reflecting surfaces.

### CROSS-REFERENCE TO RELATED APPLICATION

This application claims priority of Chinese Application No. 201110062024.6, filed on Mar. 10, 2011.

### BACKGROUND OF THE INVENTION

1. Field of the Invention

The present invention relates to a light source, more particularly to a linear light source applicable for an optical scanning module.

2. Description of the Related Art

An optical scanning module is applied to a scanner, a fax machine, or a multi-function printer (MPF) which incorporates functionality of a photocopier, a scanner, a printer and a fax machine. The optical scanning module usually includes a light source, a reflecting mirror, a focusing lens, and an image sensor.

The light source is capable of emitting light beams for illuminating a scan target. The scan target has a target pattern. The image sensor receives reflected light beams and generates electronic signals corresponding to the target pattern. The aforementioned light source generally adopts a cold cathode fluorescent lamp (CCFL) for emitting white light, and illuminates the scan target via an elongated slit. The reflected light beams from the scan target are reflected once again by the reflecting mirror and are focused by the focusing lens so as to be imaged on the image sensor. However, since the CCFL requires an inverter for providing high-voltage and high-frequency alternating current to operate, an issue of power consumption is raised. Moreover, mercury vapor filled in a lamp tube of the CCFL may pollute the environment, such that use of the CCFL is regulated in many countries.

Therefore, in recent years, optical scanning modules adopting a linear light source which is formed by a light emitting diode (LED) in cooperation with a light guide as the light source have been proposed. Referring to FIG. 1, the conventional linear light source includes a light guide 91, a LED package 92 disposed at one end of the light guide 91, and a reflecting shield 93 covering side walls of the light guide 91. A transverse section of the light guide 91 is rectangular or polygonal in shape. The light guide 91 has a light-exit surface 911, and is provided with a plurality of optical structures 912 disposed on a surface of the light guide 91 opposite to the light-exit surface 911. In this design, since light beams exiting the light-exit surface 911 are divergent light beams, aside from the light beams illuminating the scan target, the other light beams are wasted.

It is apparent from the foregoing that light energy utilization of the linear light source of the conventional optical scanning module is inferior. Accordingly, this invention seeks to reduce energy consumption and to promote scanning quality.

### SUMMARY OF THE INVENTION

Therefore, an object of the present invention is to provide a linear light source capable of emitting converging light beams, and a light guide of the linear light source.

Accordingly, the linear light source of the present invention is capable of emitting light beams for illuminating a target. The linear light source comprises a light guide, a light-emitting unit, and a reflecting layer. The light guide has a bottom surface, first and second reflecting surfaces extending from opposite side edges of the bottom surface, respectively, and a light converging convex surface connected to the first and second reflecting surfaces and curved outward with respect to the bottom surface. The first and second reflecting surfaces are symmetrical segments of an imaginary parabolic curved surface having a parabolic transverse section opening toward the light converging convex surface. The light-emitting unit is for emitting light beams that propagate along the light guide and that exit via the light converging convex surface. The reflecting layer is disposed on the first and second reflecting surfaces.

The linear light source of the present invention is for application to an optical scanning module and may be used for illumination. Therefore, the aforementioned target may be one of a scan target of an optical scanning module and anything to be illuminated by the linear light source.

Another object of the present invention is to provide an optical scanning module comprising the aforementioned linear light source for illuminating a scan target.

An effect of the present invention resides in that the linear light source uses a parabolic design of the first and second reflecting surfaces in cooperation with the light converging convex surface so as to illuminate convergently a specific region. When the linear light source is applied in the optical scanning module, even if paper to be scanned has wrinkles or is relatively thick, or even if there is assembly tolerance existing in the optical scanning module, illumination effect of the light beams is not adversely influenced, and scanning quality may be maintained.

### BRIEF DESCRIPTION OF THE DRAWINGS

Other features and advantages of the present invention will become apparent in the following detailed description of the two preferred embodiments with reference to the accompanying drawings, of which:

FIG. 1 is a perspective view illustrating a linear light source of a conventional optical scanning module;

FIG. 2 is a partly exploded perspective view illustrating a first preferred embodiment of a linear light source of an optical scanning module according to the present invention;

FIG. 3 is a schematic view illustrating light beams propagating and being refracted in a light guide according to the first preferred embodiment;

FIG. 4 is a perspective view illustrating optical structures disposed in a bottom surface of the light guide; and

FIG. 5 is a schematic view similar to FIG. 3 and illustrating a second preferred embodiment of a linear light source of an optical scanning module according to the present invention.

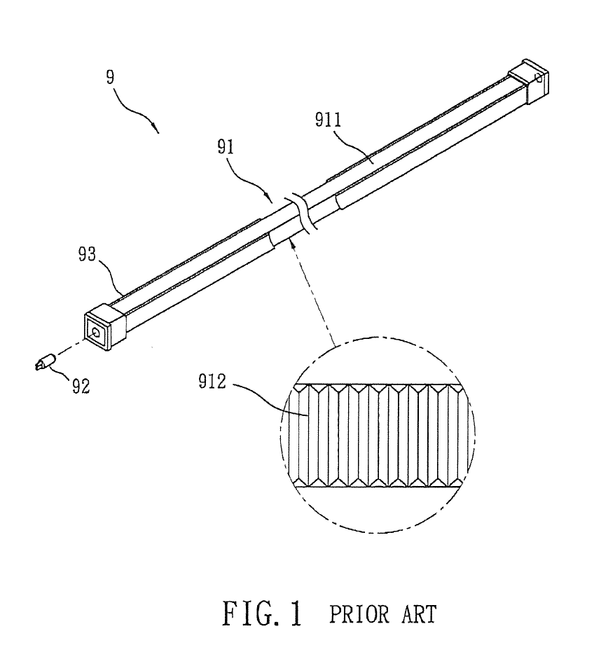

### DETAILED DESCRIPTION OF THE PREFERRED EMBODIMENTS

Before the present invention is described in greater detail with reference to the preferred embodiments, it should be noted that the same reference numerals are used to denote the same elements throughout the following description.

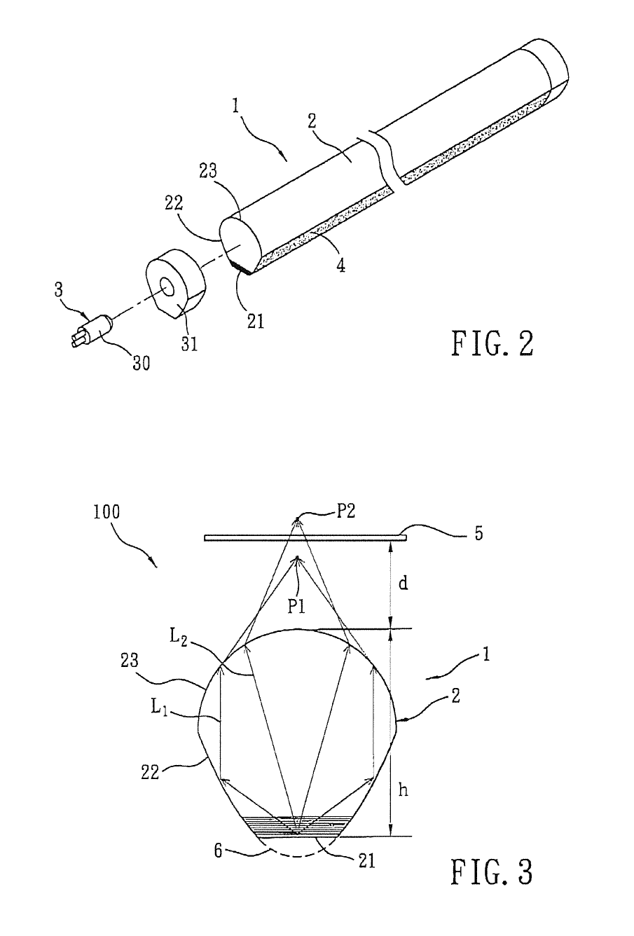

Referring to FIG. 2 and FIG. 3, a linear light source 1 of the present invention is to be applied in an optical scanning module 100. The optical scanning module 100 further includes a scan target 5. The linear light source 1 is capable of emitting light beams for illuminating the scan target 5. Since the feature of the present invention does not reside in the detailed configuration of electronic components of the optical scanning module 100, which is known in the art, further details of the same are omitted herein for the sake of brevity.

A first preferred embodiment of the linear light source 1 comprises a light guide 2, a light-emitting unit 3, and a reflecting layer 4. The scan target 5 mentioned herein is a transparent substrate for placement of a to-be-scanned object.

The light guide 2 is elongate in shape and is to be disposed parallel to and below the scan target 5. The light guide 2 has a bottom surface 21, first and second reflecting surfaces 22 extending from opposite side edges of the bottom surface 21, respectively, and a light converging convex surface 23 connected to the first and second reflecting surfaces 22 and curved outward with respect to the bottom surface 21. The light converging convex surface 23 is to be spaced apart from a lower surface of the scan target 5 by a distance (d). In this embodiment, (d) represents a distance between an apex of the light converging convex surface 23 and the scan target 5.

In this embodiment, the light-emitting unit 3 includes a light-emitting diode (LED) package 30 which is disposed at one end of the light guide 2 via a mount 31. However, the present invention is not limited to the disclosure herein. The light-emitting unit 3 may include a plurality of LED packages 30 disposed at two ends of the light guide 2, respectively. The reflecting layer 4 is disposed on the first and second reflecting surfaces 22 of the light guide 2. The reflecting layer 4 may be disposed in a covering manner, or by means of combining reflective materials with the first and second reflecting surfaces 22 via spraying, printing, or coating techniques.

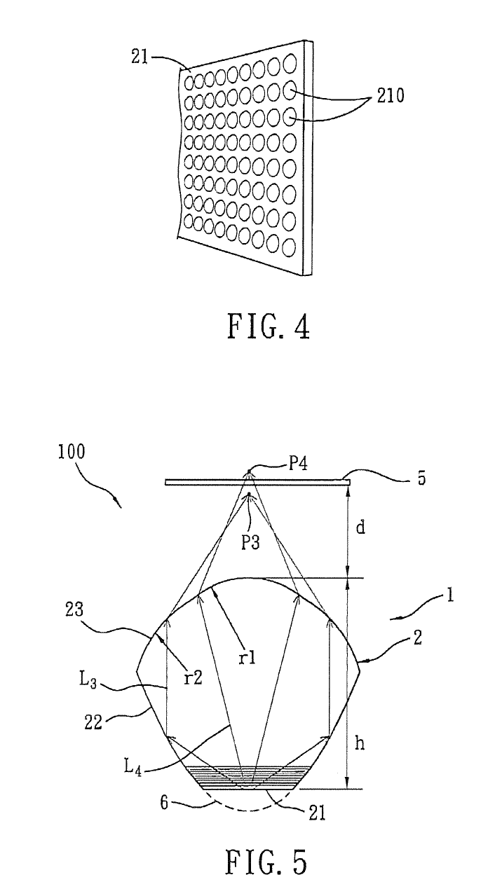

Referring to FIG. 3 and FIG. 4, the first and second reflecting surfaces 22 are symmetrical segments of an imaginary parabolic curved surface 6. The imaginary parabolic curved surface 6 has a parabolic transverse section opening toward the light converging convex surface 23. The parabolic transverse section has a focal point located at the bottom surface 21. The bottom surface 21 is provided with a plurality of optical structures 210. The optical structures 210 enable light beams emitted from the light-emitting unit 3 to propagate along the light guide 2 more evenly. Each of the optical structures 210 has a form which may be selected from a V-cut, a V-projection, a convex dot and a concave recess. Arrangement of the optical structures 210 may be selected from matrix arrangement, staggered arrangement and irregular arrangement. In this embodiment, one of the V-cut and V-projection is taken as an example of the form of each of the optical structures 210. Adjacent ones of the optical structures 210 are spaced apart by a distance (p). Each of the optical structures 210 has one of a depth and a height ranging from 0.05 p to 0.6 p.

By virtue of a parabolic design of the first and second reflecting surfaces 22, light beams emitted from the focal point of the parabolic transverse section of the imaginary parabolic surface 6 may be reflected by the segments of the imaginary parabolic curved surface 6 (i.e., the first and second reflecting surfaces 22) so as to form parallel light beams L₁. The parallel light beams L₁ are refracted by the light converging convex surface 23 and are focused at a position P₁. In this embodiment, the light converging convex surface 23 is a convex surface with a uniform radius of curvature. The position P₁ is spaced apart from the light converging convex surface 23 by a distance

$$\frac{nr}{Δ n} ,$$

in which n represents refractive index of an environment medium, Δn represents a difference value between n and n′, n′ represents refractive index of a material of the light guide 2, and r represents the radius of curvature of the light converging convex surface 23. On the other hand, the light beams emitted from the focal point of the parabolic transverse section of the imaginary parabolic surface 6 includes a portion of direct light beams L₂. The direct light beams L₂ are refracted directly by the light converging convex surface 23 and are focused at a position P₂. The position P₂ is spaced apart from the light converging convex surface 23 by a distance

$$\frac{nhr}{{n}^{′} r - h Δ n} ,$$

in which h represents a height of the light guide 2.

By means of the aforementioned design, the light beams emitted from the linear light source 1 of the first preferred embodiment may be evenly focused at the position P₁ and the position P₂ above the light converging convex surface 23. Therefore, in practice, the linear light source 1 is to be disposed below the scan target 5 such that the distance (d) between the light converging convex surface 23 and the scan target 5 ranges from

$$\frac{nr}{Δ n} to \frac{nhr}{{n}^{′} r - h Δ n} .$$

The distance (d) preferably satisfies

$$\frac{nhr}{2} ( \frac{1}{{n}^{′} r - h Δ n} + \frac{1}{h Δ n} ) .$$

In this way, a region above and below the scan target 5 may be evenly and concentratedly illuminated so as to promote scanning speed, and energy consumption of the optical scanning module 100 may be reduced resulting from higher optical efficiency. Moreover, even if paper to be scanned has wrinkles or is relatively thick, or even if there is assembly tolerance existing in the optical scanning module 100, illumination effect of the light beams is not adversely influenced, and scanning quality may be maintained.

Referring to FIG. 5, a second preferred embodiment of the linear light source 1 to be applied in the optical scanning module 100, according to the present invention, differs from the first preferred embodiment in the configurations that the light converging convex surface 23 of the light guide 2 is a convex surface with multiple radii of curvature. That is to say, there are at least two radii of curvature so that light beams may be adjusted more concentratedly. The light converging convex surface 23 is to be spaced apart from the scan target 5 by a distance (d) greater than a first distance and less than a second distance. The first distance is a distance between the light converging convex surface 23 and a focal point of the light converging convex surface 23. The second distance is a distance between the light converging convex surface 23 and an imaging point of the light converging convex surface 23 relative to the focal point of the parabolic transverse section of the imaginary parabolic curved surface 6. Referring to FIG. 5, a central region of the light converging convex surface 23 has a first radius of curvature r1, and a peripheral region of the light converging convex surface 23 adjacent to the first and second reflecting surfaces 22 has a second radius of curvature r2 different from the first radius of curvature r1.

By virtue of the parabolic design of the first and second reflecting surfaces 22, the light beams emitted from the focal point of the parabolic transverse section of the imaginary parabolic surface 6 may be reflected by the first and second reflecting surfaces 22 so as to form parallel light beams L₃. The parallel light beams L₃ are refracted by the peripheral region of the light converging convex surface 23 having the radius of curvature r2 and are focused at a position P₃. The position P₃ is spaced apart from the light converging convex surface 23 by a distance

$$\frac{{nhr}_{2}}{{n}^{′} {r}_{2} - h Δ n} .$$

On the other hand, the light beams emitted from the focal point of the parabolic transverse section of the imaginary parabolic surface 6 includes a portion of direct light beams L₄. The direct light beams L₄ are refracted directly by the central region of the light converging convex surface 23 having the radius of curvature r1 and are focused at a position P. The position P₄ is spaced apart from the light converging convex surface 23 by a distance

$$\frac{{nhr}_{1}}{{n}^{′} {r}_{1} - h Δ n} .$$

By means of the aforementioned design, the light beams emitted from the linear light source 1 of the second preferred embodiment may be evenly focused at the position P₃ and the position P₄ above the light converging convex surface 23. Therefore, in practice, the linear light source 1 is to be disposed below the scan target 5 such that the distance (d) between the light converging convex surface 23 and the scan target 5 ranges from

$$\frac{{nhr}_{2}}{{n}^{′} {r}_{2} - h Δ n} to \frac{{nhr}_{1}}{{n}^{′} {r}_{1} - h Δ n} .$$

The distance (d) preferably satisfies

$$\frac{nh}{2} ( \frac{{r}_{2}}{{n}^{′} {r}_{2} - h Δ n} + \frac{{r}_{1}}{{n}^{′} {r}_{1} - h Δ n} ) .$$

In this way, a region above and below the scan target 5 may be evenly and concentratedly illuminated so as to promote scanning speed, and energy consumption of the optical scanning module 100 may be reduced resulting from higher optical efficiency.

In summary, the linear light source 1 of the present invention is to be applied in the optical scanning module 100 and makes use of a characteristic that the light beams emitted from the focal point of the parabolic transverse section of the imaginary parabolic surface 6 are reflected so as to form the parallel light beams, in cooperation with the light converging convex surface 23 for converging light so as to effectively concentrate light beams at the scan target 5. In this way, not only is brightness of a scanning region promoted, but light energy is also saved. Generally, a demand for electrical power of the linear light source may be effectively reduced.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A linear light source capable of emitting light beams for illuminating a target, said linear light source comprising:
a light guide having
a bottom surface,
first and second reflecting surfaces extending from opposite side edges of said bottom surface, respectively, and
a light converging convex surface connected to said first and second reflecting surfaces and curved outward with respect to said bottom surface,
said first and second reflecting surfaces being symmetrical segments of an imaginary parabolic curved surface having a parabolic transverse section opening toward said light converging convex surface;
a light-emitting unit for emitting light beams that propagate along said light guide and that exit via said light converging convex surface; and
a reflecting layer disposed on said first and second reflecting surfaces.

2. The linear light source as claimed in claim 1, wherein the parabolic transverse section has a focal point located at said bottom surface.

3. The linear light source as claimed in claim 1, wherein said bottom surface is provided with a plurality of optical structures.

4. The linear light source as claimed in claim 3, wherein each of said optical structures is selected from a V-cut and a V-projection, adjacent ones of said optical structures being spaced apart by a distance (p), each of said optical structures having one of a depth and a height ranging from 0.05 p to 0.6 p.

5. The linear light source as claimed in claim 1, wherein said light converging convex surface is a convex surface with a uniform radius of curvature, and is to be spaced apart from the target by a distance ranging from
$$\frac{nr}{Δ n} to \frac{nhr}{{n}^{′} r - h Δ n} ,$$
in which n represents refractive index of an environment medium, n′ represents refractive index of a material of said light guide, Δn represents a difference value between n and n′, h represents a height of said light guide, and r represents the radius of curvature of said light converging convex surface.

6. The linear light source as claimed in claim 5, wherein the distance between the target and said light converging convex surface satisfies:
$$\frac{nhr}{2} ( \frac{1}{{n}^{′} r - h Δ n} + \frac{1}{h Δ n} ) .$$

7. The linear light source as claimed in claim 1, wherein said light converging convex surface is a convex surface with multiple radii of curvature, and is to be spaced apart from the target by a distance greater than a first distance and less than a second distance, the first distance being a distance between said light converging convex surface and a focal point of said light converging convex surface, the second distance being a distance between said light converging convex surface and an imaging point of said light converging convex surface relative to a focal point of the parabolic transverse section of the imaginary parabolic curved surface.

8. The linear light source as claimed in claim 7, wherein a central region of said light converging convex surface has a first radius of curvature r1, a peripheral region of said light converging convex surface adjacent to said first and second reflecting surfaces having a second radius of curvature r2 different from the first radius of curvature r1, the distance between the target and said light converging convex surface ranging from
$$\frac{{nhr}_{2}}{{n}^{′} {r}_{2} - h Δ n} to \frac{{nhr}_{1}}{{n}^{′} {r}_{1} - h Δ n} ,$$
in which n represents refractive index of an environment medium, n′ represents refractive index of a material of said light guide, Δn represents a difference value between n and n′, and h represents a height of said light guide.

9. The linear light source as claimed in claim 8, wherein the distance between the target and said light converging convex surface satisfies:
$$\frac{nh}{2} ( \frac{{r}_{2}}{{n}^{′} {r}_{2} - h Δ n} + \frac{{r}_{1}}{{n}^{′} {r}_{1} - h Δ n} ) .$$

10. A light guide for a linear light source, said light guide comprising:
a light guide body having
a bottom surface,
first and second reflecting surfaces extending from opposite side edges of said bottom surface, respectively, and
a light converging convex surface connected to said first and second reflecting surfaces and curved outward with respect to said bottom surface,
said first and second reflecting surfaces being symmetrical segments of an imaginary parabolic curved surface having a parabolic transverse section opening toward said light converging convex surface.

11. An optical scanning module comprising a linear light source as claimed in claim 1 for illuminating a scan target.
